(19) United States
(12) Patent Application Publication
(10) Pub. No.: US 2002/0182910 A1
(43) Pub. Date: Dec. 5, 2002

(54) Swivelled electric outlet receptacle

(76) Inventors: Tony Kiughadush, Santa Monica, CA (US); Danny H. Kulghadush, Briarwood, NY (US)

Correspondence Address: SOFER & HAROUN, L.L.P., Suite 1921, 342 Madison Avenue, New York, NY, 10173, US

(21) Appl. No.: 10/040,970

(22) Filed: Jan. 7, 2002

Related U.S. Application Data
(60) Provisional application No. 60/260,078, filed on Jan. 5, 2001.

(51) Int. Cl. H01R 29/00

(52) U.S. Cl. 439/171

(57) ABSTRACT

A swivelled electrical outlet receptacle includes a swivel unit that can rotate in all directions. The swivel unit is disposed on a holder with a ball and joint socket arrangement. The swivel unit is placed in a housing and is supported by the swivel holder on one side and a face plate, or front panel, on the other side. The swivel unit housing in turn is disposed in an electrical box wall unit. The box wall unit is disposed within a wall opening similar to conventional outlet boxes. The swivel unit has a spherical shape, which allows it to rotate in up and down directions against a plane parallel to the plane of the face plate of the swivel unit. The swivel unit can also rotate in a clockwise or counter clockwise direction. In accordance with another embodiment of the invention, the swivel unit is arranged to rotate via a cam-hinge arrangement. As such the swivel unit is capable to rotate a full 180° in all directions.

### FIELD OF THE INVENTION

This invention relates to outlet connectors and more specifically to swivelled electrical outlet receptacles.

### BACKGROUND OF THE INVENTION

There are many instances where electrical plugs in outlet receptacles are disengaged by pulling the electrical cord from a distance an at an angle that can cause damage to the plugs. This typically happens, when for example, a furniture piece is obstructing the plug that is engaged in the outlet receptacle behind the furniture. Many users, instead of moving the furniture to disengage the plug, pull on the cord from a distance. The force exerted on the plug forms an angle with the plug, which may lead to the damage to the plug. Furthermore, because of the angle the user has to exert more force in order to disengage the plug.

In other circumstances, users who typically operate an electrical appliance that has a long cord connection to the outlet, frequently attempt to disengage the plug from a distance away from the outlet. This happens with users of blow dryers, or users of vacuum cleaners. Again, as a result of such use, electrical plugs are frequently damaged and need to be replaced.

Thus, there is a need for an outlet that enables users to disengage plugs remotely and conveniently, without damaging them.

### SUMMARY OF THE INVENTION

In accordance with one embodiment of the invention a sWIVELLED electrical outlet receptacle includes a swivel unit that can rotate in all directions. The swivel unit is disposed on a holder with a ball and joint socket arrangement. The swivel unit includes female prongs so as to receive the prongs of an electrical plug. The swivel unit is placed in a housing and is supported by the swivel holder on one side and a face plate, or front panel, on the other side. The swivel unit housing in turn is disposed in an electrical box wall unit. The box wall unit is disposed within a wall opening similar to conventional outlet boxes.

In accordance with one embodiment of the invention, the swivel unit has a spherical shape, which allows it to rotate in up and down directions against a plane parallel to the plane of the face plate of the swivel unit. The swivel unit can also rotate in a clockwise or counter clockwise direction. Thus, during operation, as a user attempts to pull the plug from a distance, the swivel unit rotates so as to align the plug along the direction of the pulling force. This arrangement substantially reduces the force that is exerted perpendicular to the plug and hence prevents damage to the plug.

In accordance with another embodiment of the invention, the entire swivel unit is arranged as an add-on unit which can be plugged into an existing outlet receptacle in a convenient fashion. For this embodiment the swivel unit is disposed in an add-on box, and is retained by the swivel unit holder in a ball and joint socket arrangement. The add-on box further comprises a back panel that includes male prongs that act as an electrical plug so as to engage with the existing outlet receptacle located on a wall. Once the add-on box is plugged in the outlet receptacle, the user may connect a desired appliance to the swivel unit receptacle.

In accordance with yet another embodiment of the invention, the swivel unit is arranged to rotate via a cam-hinge arrangement. For this embodiment, a swivel unit includes a retaining panel, on which two hinges are disposed. A U-shaped cam unit is engaged with the two hinges. On the middle portion of the cam the swivel unit is connected via a second hinge arrangement. As such the swivel unit is capable to rotate a full 180° in all directions.

### BRIEF DESCRIPTION OF THE DRAWINGS

FIGS. 1A-1C illustrate a swivel unit with and wall unit box in accordance with one embodiment of the invention.

FIG. 2 illustrates a swivel unit box being inserted in the wall unit box, along with the electrical connections in accordance with one embodiment of the invention.

FIGS. 3A and 3B respectively illustrates the front and back panels of a swivel unit for an add-on arrangement in accordance with one embodiment of the invention.

FIG. 3C illustrates a swivel unit box for an add-on arrangement with electrical prongs and a lock throng disposed on its back panel in accordance with one embodiment of the invention. The swivel unit box illustrated in FIG. 3C can be also employed for built in arrangement by disengaging male prongs and the anchor plug.

FIG. 3D illustrates an existing electrical outlet receptacle disposed in a wall, wherein the add-on swivel unit box is plugged into it in accordance with one embodiment of the invention.

FIG. 3E illustrates another add-on swivel unit box in accordance with one embodiment of the invention.

FIGS. 4A-4C illustrate the back panel of swivel unit box in accordance with one embodiment of the invention.

FIGS. 5A-5D illustrate various components of the swivel unit box in accordance with one embodiment of the invention.

FIG. 6A illustrates a swivel unit with an outlet receptacle in accordance with one embodiment of the invention.

FIG. 6B is a side view of the swivel unit illustrated in FIG. 6A.

FIG. 6C illustrates the back view of the swivel unit illustrated in FIG. 6A.

FIG. 6D illustrates the front view of the swivel unit illustrated in FIG. 6A.

FIG. 6E illustrates a swivel unit in accordance with another embodiment of the invention.

FIG. 6F illustrates the back view of the receptacle portion of the swivel unit of FIGS. 6A and 6E, with the connection cords that connect to contact points illustrated in FIG. 6C in accordance with one embodiment of the invention.

FIG. 6G illustrates one female prong receptacle of the swivel unit from the side view in accordance with one embodiment of the invention.

FIGS. 7A-7J illustrates various views of a swivel unit having a cam-hinge arrangement in accordance with one embodiment of the invention.

FIGS. 8A and 8B illustrate a perspective diagram of the add-on version of a swivel unit outlet receptacle in accordance with one embodiment of the invention.

FIG. 9 illustrates a perspective diagram of the cam-hinge version of a swivel unit outlet receptacle in accordance with one embodiment of the invention.

FIG. 10 illustrates a perspective diagram of a built-in version of swivel unit outlet receptacle in accordance with one embodiment of the invention.

FIG. 11 illustrates a swivel unit in accordance with another embodiment of the invention.

### DETAILED DESCRIPTION OF THE DRAWINGS

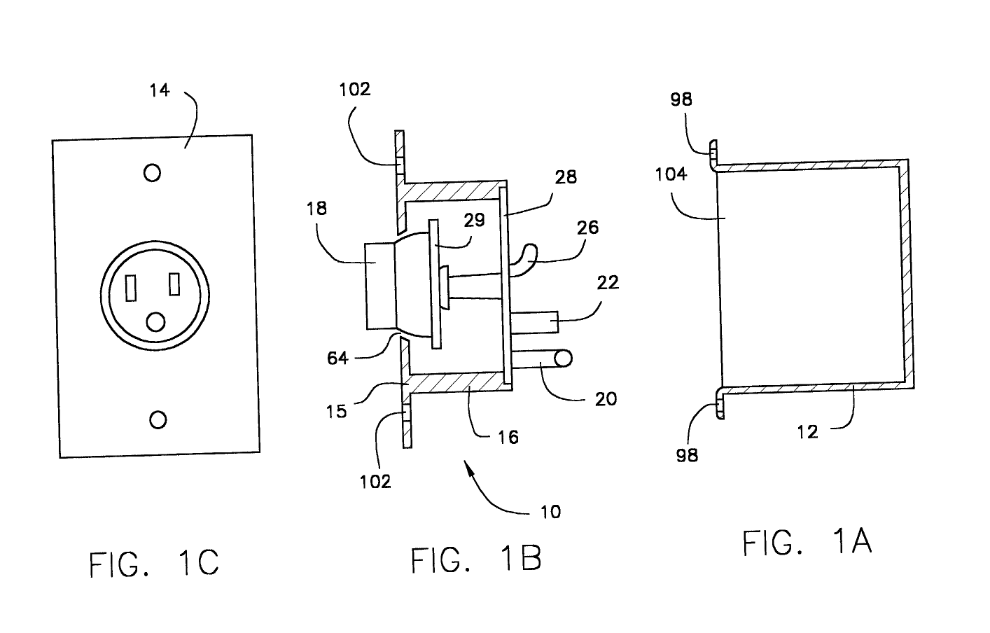

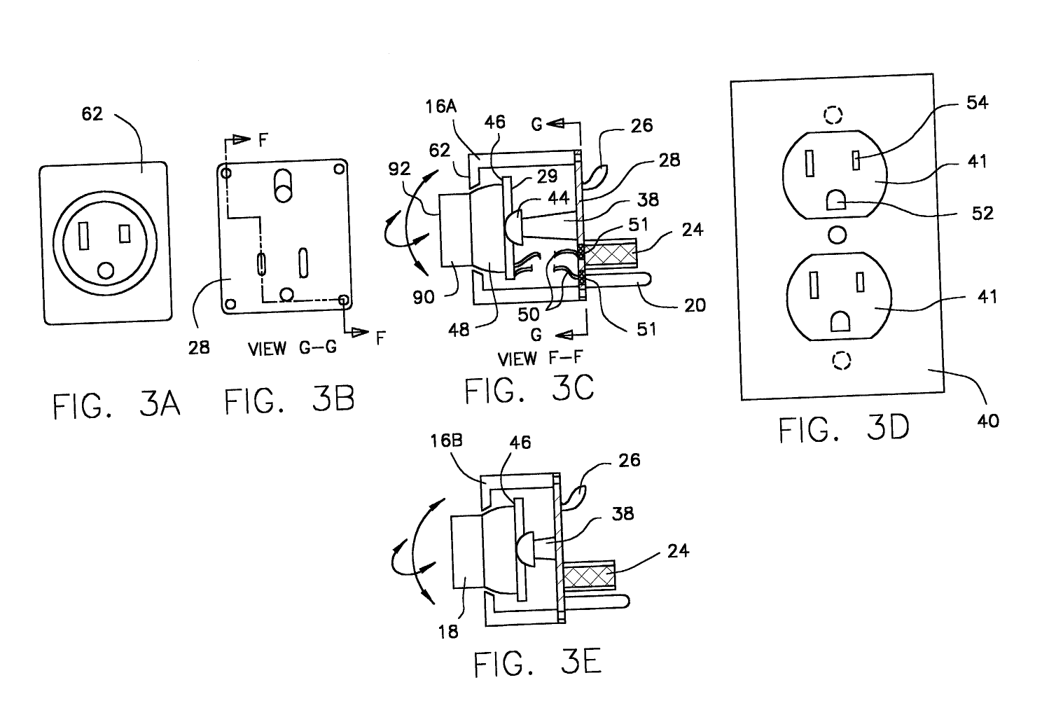

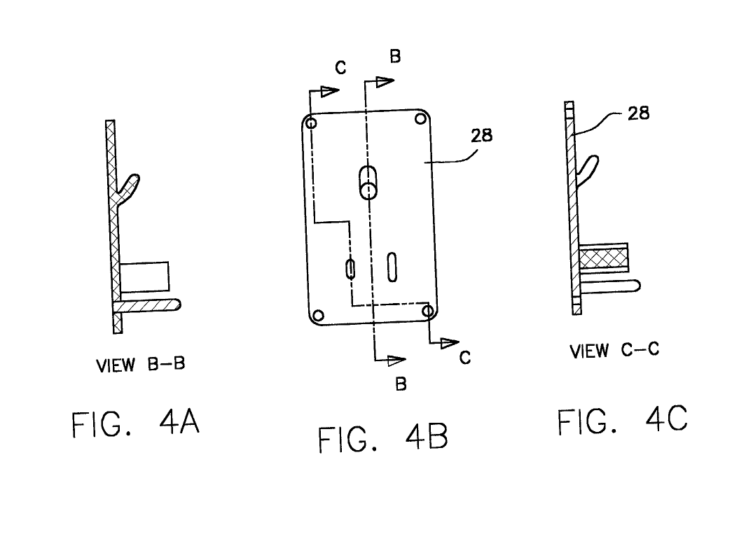

FIGS. 1B and 3C illustrate an outlet receptacle swivel unit housing 10 in accordance with one embodiment of the invention. Housing 10 includes a box 16 that includes four side walls and a front panel 15, and a back panel 28 (FIGS. 4A, 4B and 4C). Front panel 15 defines a front panel opening 64 for receiving swivel unit 18.

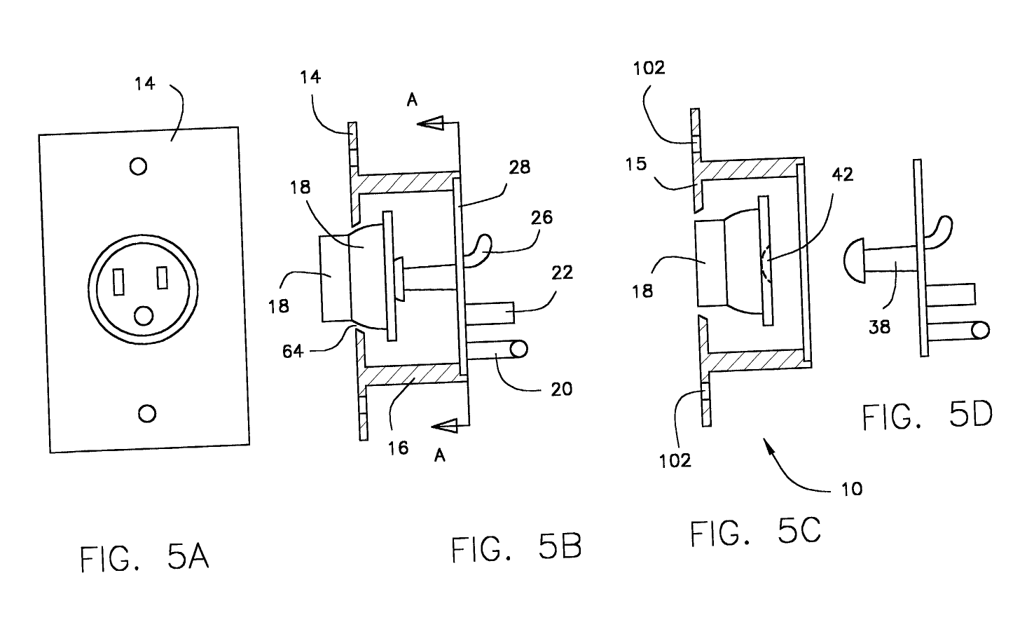

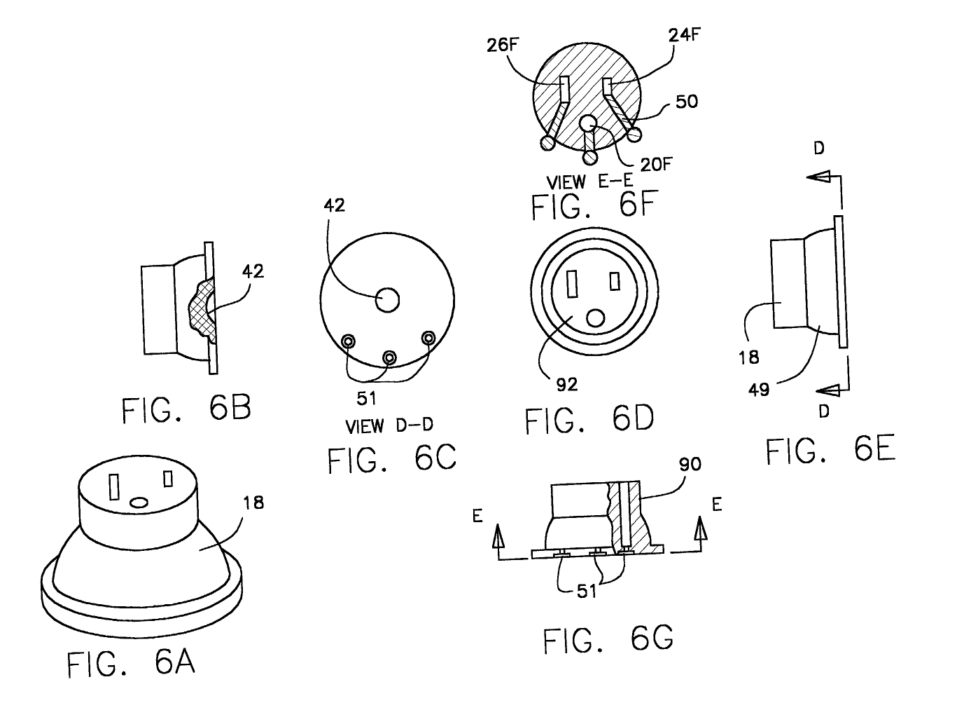

Swivel unit 18 includes a receptacle portion 90, also illustrated in FIG. 6G, having a front surface 92 (FIG. 6D) that is configured to receive male prongs of a conventional electrical plug. Extending from the receptacle portion 90 is an arcuate surface 48 that defines the side surface of swivel unit 18. In accordance with another embodiment of the invention, as illustrated in FIG. 6E, instead of arcuate surface 48, swivel unit 18 includes a tapered surface 49.

A swivel unit back panel 29 encloses the back portion of swivel unit 18. Back panel 29 includes extension tab stoppers 46, which engage against the edges of opening 64 so as to limit the movement of swivel unit beyond the opening. Back panel 29 includes a socket portion 42 that defines a concave surface within the swivel unit. In accordance with one embodiment of the invention, the surface of socket portion 42 is coated with Teflon or PVC or other non-corrosive material.

A swivel unit holder 38 is attached to the inside surface of back panel 28. Swivel unit holder 38 includes a stem portion 32 that extends from the inside surface of back panel 28 towards socket portion 42. At the other end of swivel unit holder 38 a ball portion 44 is disposed that engages within socket portion 42, so as to retain swivel unit 18. As such swivel unit 18 is enabled to rotate around ball portion 44 in a ball and joint socket arrangement. It is noted that in accordance with one embodiment of the invention, the surface of ball portion 44 is also coated with Teflon or PVC or other non-corrosive material, so as to allow a longer lasting swivel unit.

Electrical wiring 50, such as copper wires, are connected between the swivel unit receptacle outlet and connector holes 51 disposed on back panel 28. FIG. 6F illustrates electrical wires 50 extending from female receptacle prongs 24(F) and 26(F) and ground receptacle prong 20(F) towards connector holes 51 (FIG. 6C). Back panel 28 further includes two prongs 24 and a ground prong 20, which are removably attached to connector holes 51. Back panel 28 also includes a lock thong 26 that has an arcuate shape.

Swivel unit housing in accordance with one embodiment of the invention is employed as an add-on unit as illustrated in FIG. 3C, which can be plugged into a conventional wall outlet unit 40. Typically, wall outlet units have two plug receptacles 41. As such prongs 24 and 20 are plugged into one receptacle 41 and lock thong 26 is plugged into a female ground prong such as 52 of the second receptacle 41. Lock thong 26 provides additional security, to prevent add-on unit housing 10 to disengage from the wall unit receptacle when it is pulled away by an electrical cord from a distance.

FIG. 3E illustrates another swivel unit housing in accordance with one embodiment of the invention. As illustrated the length of the stem portion of swivel unit holder is smaller than the length of the swivel unit holder illustrated in FIG. 3C so as to have a smaller unit. For example, whereas a typical width for swivel unit housing illustrated in FIG. 3C is about 40 mm, the width of the housing in FIG. 3E is about 23 mm.

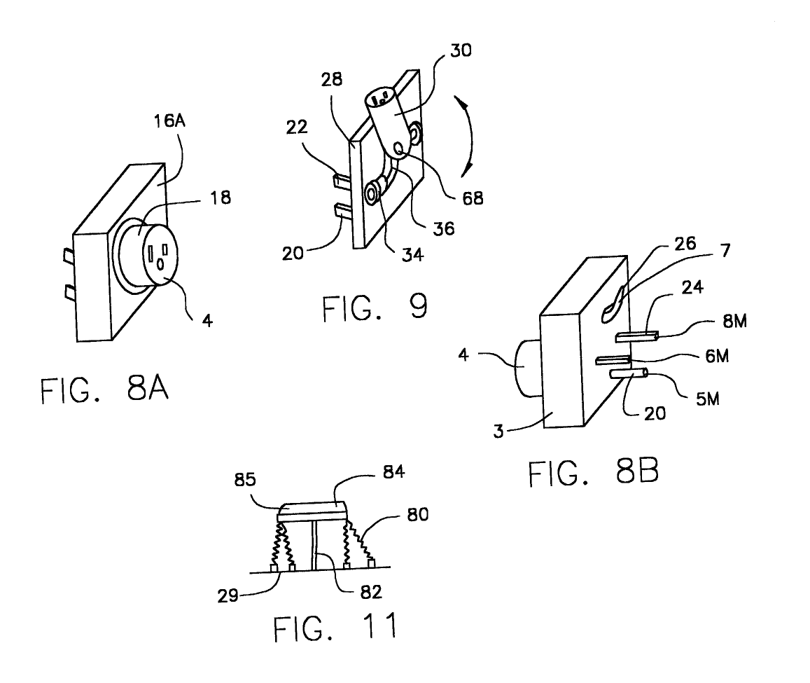

FIGS. 8A and 8B illustrate the add-on version of swivel unit housing 10. As illustrated swivel unit 18 is enabled to rotate around the axes defined by ball and joint socket arrangement illustrated in FIG. 3C.

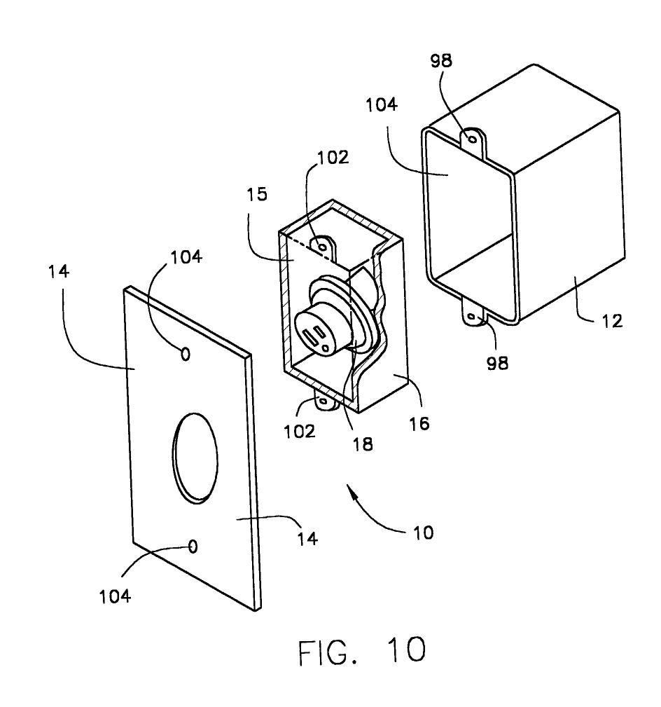

FIGS. 1B, 2 and 10 illustrate the built-in version of swivel unit housing, in accordance with another embodiment of the invention. In accordance with this embodiment, a box wall unit 12 includes five closed sides and a front open side 104. Tabs 98 are disposed on the edges of open side 104. Tabs 98 include threaded holes to receive screws that removably attach swivel unit housing 10 to box 12.

The dimensions of swivel unit housing 10 is configured to be smaller than the dimensions of box 12, so that it can be inserted within the box. Swivel unit housing 10 includes a front panel 15 that defines an opening so as to retain swivel unit 18. Tabs 102 are disposed on the edges of front panel 15. Tabs 02 also include threaded holes to receive the same screws that removably attach swivel unit housing 10 to box 12.

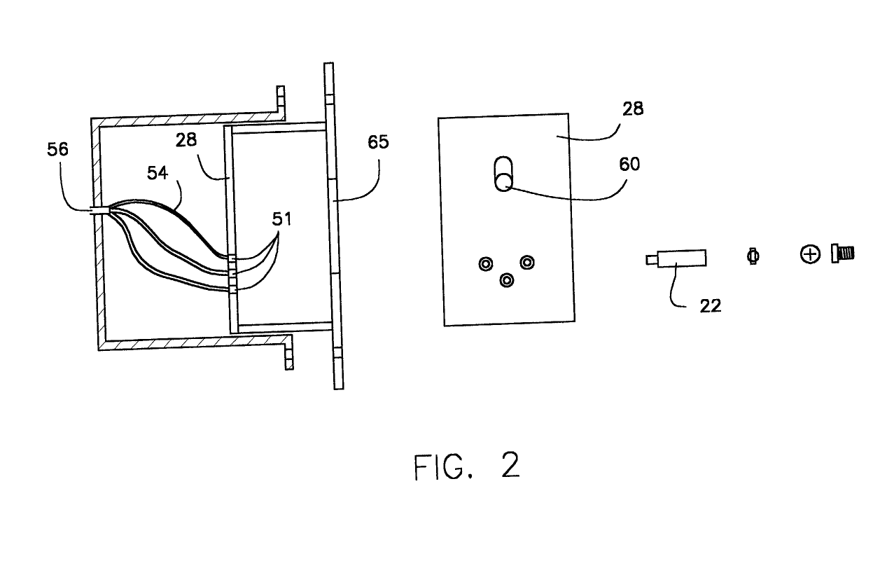

It is noted that for the built-in version, prongs 22 and 20 and lock thong 26 are disengaged from back panel 28, as illustrated in FIG. 2. Furthermore, electrical house wires 54 connect house electrical line 56 to connector holes 51.

Finally a front plate 14 includes holes 104 and an opening 65 that is configured to be aligned with opening 64 of plate 15. During installation, swivel unit housing is inserted inside box 12 and cover plate 14 is attached to the front side of swivel unit housing 10. Two screws are then inserted through the holes 104 of plate 14 and threaded holes of tabs 102 and 98 to securely and removably attach plate 14 to housing 10 and box 12. Thereafter, box 12 is inserted within the opening in the wall.

In accordance with another embodiment of the invention, as illustrated in FIGS. 5A and 5B, instead of having a front panel 15, swivel unit housing 10 receives front panel 14 directly on its front surface to retain swivel unit 18. Whereas, FIG. 5C illustrates the embodiment that includes front panel 15 for housing 10.

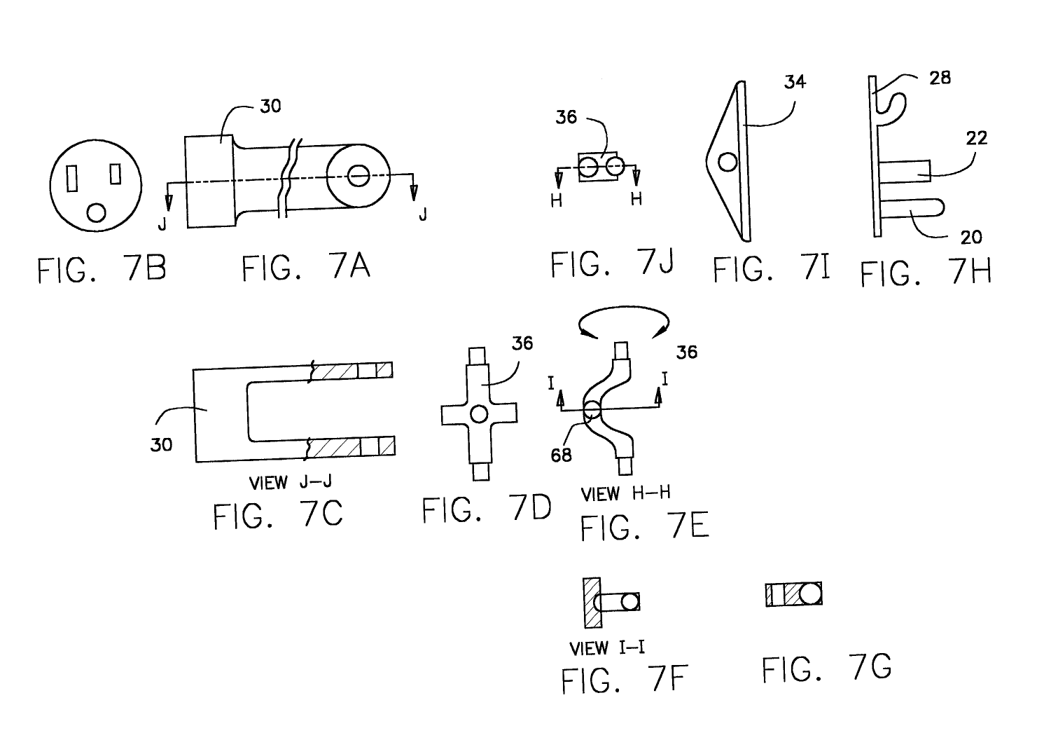

FIG. 9 illustrates a cam-hinge arrangement for an outlet receptacle swivel unit in accordance with another embodiment of the invention. Thus a panel 28 is configured to retain the male prongs 22, 20 and lock thong 26 on one side and the swivel unit 30 on its front side. Furthermore, the front side of panel 28 includes two hinges 34 that are disposed on opposite end portions of the front side of panel 28. As illustrated in FIG. 7I, hinges 34 may have other configurations, and the invention is not limited in scope to any hinge configuration. Arcuate cam 36 is engaged within hinges 34 and is configured to rotate up and down as illustrated in FIG. 9 and FIG. 7E.

Swivel unit 30 is hingedly connected to cam 36 via threaded hole 68, which defines the axis of rotation of swivel unit 30, along arcuate cam 36. As such swivel unit 30 is enabled to rotate towards hinges 34 in opposite directions. Thus, the movement of cam 36 within hinges 34 and movement of swivel unit 30 along cam 36 allows the swivel unit to have a full 180° rotation along all directions.

FIG. 11 shows a swivel unit 84 in accordance with another embodiment of the invention. Swivel unit 84 includes a receptacle portion 85 that is configured to receive male prongs of an electrical plug. Receptacle portion 85 is coupled to back panel 29 via a flexible tube 82 referred to as BX support or FLEXI tube, which is strong and flexible. The wiring of swivel unit 84 are disposed within tube 82. Springs 80 are attached between receptacle portion 85 and back panel 29 to flexibly support receptacle portion 85. In accordance with this embodiment of the invention, swivel unit 84 can move in any desired direction by bending tube 82 and extending springs 80.

We claim:

1. A receptacle swivel unit comprising:
a housing for enclosing a rotatable swivel unit, said housing including a front panel for receiving said swivel unit;
a receptacle portion coupled to said swivel unit having a front surface that is configured to receive male prongs of an electrical plug;
said swivel unit further defining a narrowing surface on its sides so as to allow a rotating movement along at least two axis of rotation, said swivel unit rotating so as to align a plug inserted in said receptacle portion along a direction of a force pulling on said plug.

2. The receptacle swivel unit in accordance with claim 1, wherein said narrowing surface is arcuate.

3. The receptacle swivel unit in accordance with claim 1, wherein said narrowing surface is a tapering surface.

4. The receptacle swivel unit in accordance with claim 1, wherein said swivel unit is coupled to said housing in a ball and joint socket arrangement

5. The receptacle swivel unit of claim 1, wherein said rotatable swivel unit includes a back panel having extension tab stoppers so as to limit the movement of said rotatable swivel unit.

6. The receptacle swivel unit in accordance with claim 1, wherein said housing further comprises a back panel having prongs removably attached to a plurality of connector holes, such that said receptacle swivel unit is insertable into a wall outlet.
